(19) United States
(12) Patent Application Publication
(10) Pub. No.: US 2003/0120821 A1
(43) Pub. Date: Jun. 26, 2003

(54) Wireless local area network access management

(76) Inventors: Jeffrey L. Thermond, Saratoga, CA (US); Richard G. Martin, Morgan Hill, CA (US)

Correspondence Address: Bruce E. Garlick, P.O. Box 160727, Austin, TX, 78716-0727, US

(21) Appl. No.: 10/271,968

(22) Filed: Oct. 15, 2002

Related U.S. Application Data
(60) Provisional application No. 60/342,684, filed on Dec. 21, 2001.

(51) Int. Cl. G06F 15/173

(52) U.S. Cl. 709/250; 709/223

(57) ABSTRACT

Wireless Access Points (WAPs) of a Wireless Local Area Network (WLAN) are managed to reduce registration and authentication overhead for roaming wireless terminals. In one embodiment, during initial registration with a first WAP, at least some other WAPs receive registration information regarding the wireless terminal. When the wireless terminal roams to other WAPs, registration information is present and registration latency is reduced. Visitor access to the network is supported in a limited fashion. Visiting wireless terminals are provided with limited access to the WLAN via a Virtual Private Network (VPN). The VPN is configured to service communications for visiting wireless terminals by routing communications from/to the edge of the network and by precluding access to other portions of the WLAN.

### CROSS REFERENCE TO RELATED APPLICATION

This application claims priority to U.S. Provisional Patent Application Serial No. 60/342,684, filed Dec. 21, 2001, which is incorporated herein by reference.

### 1. FIELD OF THE INVENTION

This invention relates generally to the merging of wired and wireless local area networks; and more particularly to the management of wireless local area network components within a merged network.

### 2. BACKGROUND OF THE INVENTION

Communication technologies that link electronic devices in a networked fashion are well known. Examples of communication networks include wired packet data networks, wireless packet data networks, wired telephone networks, wireless telephone networks, and satellite communication networks, among other networks. These communication networks typically include a network infrastructure that services a plurality of client devices. The Public Switched Telephone Network (PSTN) is probably the best-known communication network that has been in existence for many years. The Internet is another well-known example of a communication network that has also been in existence for a number of years. These communication networks enable client devices to communicate with one another other on a global basis. Wired Local Area Networks (wired LANs), e.g., Ethernets, are also quite common and support communications between networked computers and other devices within a serviced area. Wired LANs also often link serviced devices to Wide Area Networks and the Internet. Each of these networks is generally considered a “wired” network, even though some of these networks, e.g., the PSTN, may include some transmission paths that are serviced by wireless links.

Wireless networks have been in existence for a relatively shorter period. Cellular telephone networks, wireless LANs (WLANs), and satellite communication networks, among others, are examples of wireless networks. Relatively common forms of WLANs are IEEE 802.11(a) networks, IEEE 802.11(b) networks, and IEEE 802.11(g) networks, referred to jointly as “IEEE 802.11 networks.” In a typical IEEE 802.11 network, a wired backbone couples to a plurality of Wireless Access Points (WAPs), each of which supports wireless communications with computers and other wireless terminals that include compatible wireless interfaces within a serviced area. The wired backbone couples the WAPs of the IEEE 802.11 network to other networks, both wired and wireless, and allows serviced wireless terminals to communicate with devices external to the IEEE 802.11 network.

WLANs provide significant advantages when servicing portable devices such as portable computers, portable data terminals, and other devices that are not typically stationary and able to access a wired LAN connection. However, WLANs provide relatively low data rate service as compared to wired LANs, e.g., IEEE 802.3 networks. Currently deployed wired LANs provide up to one Gigabit/second bandwidth and relatively soon, wired LANs will provide up to 10 Gigabit/second bandwidths. However, because of their advantages in servicing portable devices, WLANs are often deployed so that they support wireless communications in a service area that overlays with the service area of a wired LAN. In such installations, devices that are primarily stationary, e.g., desktop computers, couple to the wired LAN while devices that are primarily mobile, e.g., laptop computers, couple to the WLAN. The laptop computer, however, may also have a wired LAN connection that it uses when docked to obtain relatively higher bandwidth service.

Other devices may also use the WLAN to service their communication needs. One such device is a WLAN phone, e.g., an IEEE 802.11 phone that uses the WLAN to service its voice communications. The WLAN communicatively couples the IEEE 802.11 phone to other phones across the PSTN, other phones across the Internet, other IEEE 802.11 phones, and/or to other phones via various communication paths. IEEE 802.11 phones provide excellent voice quality and may be used in all areas serviced by the WLAN.

Significant problems exist, however, when using a WLAN to support voice communications. Because the WLAN services both voice and data communications, the WLAN may not have sufficient capacity to satisfy the low-latency requirements of the voice communication. These capacity limitations are oftentimes exacerbated by channel limitations imposed in many IEEE 802.11 installations. Further, roaming within a WLAN (between WAPs) can introduce significant gaps in service, such gaps in service violating the low-latency requirements of the voice communication.

Additional significant shortcomings relate to the traditional deployment of the WLANs themselves. A traditional WLAN installation includes a wired backbone and a plurality of WAPs that couple to the wired backbone. Each of the WAPs requires management to ensure that it adequately services its own load and so that it does not unduly interfere with the operation of its neighboring WAPs. The management of a WLAN is therefore additive to the management of a wired LAN and, in most installations, is more difficult. Typically, for a particular serviced premises, e.g., campus setting, a single edge router services both the wired LAN and the WLAN in providing access to the Internet, to a Wide Area Network, etc. Thus, even though the wired LAN and the WLAN service the same premises and couple to the outside world via the same edge router, completely separate infrastructures are required to service each.

When a WLAN services a premises according to a standardized communication protocol, e.g., IEEE 802.11(a), IEEE 802.11(b), IEEE 802.11(g), etc., visitors are able to access the WLAN. However, the WLAN provides access to confidential and proprietary resources in most campuses. Thus, security access operations are typically installed to prevent unauthorized access to the WLAN. When the premises are open to visitors, the visitors would like to wirelessly access their email, to access the Internet, and to access their respective WANs. Many buildings that make up the premises are constructed so that they partially (or fully) shield cellular Radio Frequency (RF) transmissions. Thus, visiting wireless devices, even if they support cellular data service, they can oftentimes not access their servicing cellular network at acceptable data rates.

Thus, there is a need in the art for improvements in the operation and management of WLANs, particularly when the WLANs are installed additionally to wired LANs.

### SUMMARY OF THE INVENTION

In order to overcome the above-cited shortcomings of the prior WLANs, among other shortcomings, a Wireless Local Area Network (WLAN) is operated in conjunction with a wired Local Area Network (wired LAN) to service a premises, e.g., a campus setting. With a system constructed according to the present invention, a wired LAN services the wired communication needs of the premises and serves as the wired backbone of a WLAN. A plurality of Wireless Access Points (WAPs) couple to the wired backbone of the wired LAN and are serviced by the wired LAN switch(es) coupled thereto. The wired LAN switch(es) that manage the WAPs may be campus core routers, building/floor routers, or other wired LAN switches. The wired LAN switch(es) that operate according to the present invention to manage the WAPs perform operations at protocol layers two through seven and are generally referred to as “multi-layer switches”. The multi-layer switches may also be referred to as Layer 7 switches, switch routers, Layer 2+ switches, etc.

According to the present invention, WAPs in a premises are managed to reduce registration and authentication overhead for roaming terminals. In prior operations, each time that a terminal established service with a different WAP, the WAP performed registration and authentication for the terminal, a process that may take seconds. Such registration and authentication processes are inconsistent with the low latency requirements of voice calls. Further, the delay caused by the registration and authentication process could also disrupt large data transfers. Thus, according to the present invention, registration and authentication operations are streamlined, reduced, or eliminated for users registered with the wireless LAN. While registration and authentication will still be required, it will be limited in scope to reduce or eliminate any disruption in service. In one example of such reduction in registration and authentication operation, each WAP is managed by the network management server so that it identifies each terminal registered with the network management server.

According to a further aspect of the present invention, visitor access to the network is supported in a limited fashion. With this operation, visiting laptop computers (and other devices) that are wireless LAN enabled and that enter the service area of the network are provided limited access to the wireless LAN. With this limited access, the visiting laptop computers may access the Internet and other external networks. According to the present invention, such limited access is provided by configuring a segment of the wireless network as a Virtual Private Network (VPN). This VPN is configured to service communications for the visiting laptop computer to a router at the edge of the network and to preclude the visiting laptop from accessing any other portion of the network. In this manner, switches between the servicing WAP and an edge node are configured to route all traffic sent from, and intended for the visiting laptop directly between the router at the edge node of the network and the servicing WAP. These operations improve security for the network while providing the wireless visitors with access to outside networks.

Other features and advantages of the present invention will become apparent from the following detailed description of the invention made with reference to the accompanying drawings.

### BRIEF DESCRIPTION OF THE DRAWINGS

These and other features, aspects and advantages of the present invention will be more fully understood when considered with respect to the following detailed description, appended claims and accompanying drawings wherein:

FIG. 1 is a system diagram illustrating a premises in which a network constructed according to the present invention is deployed;

FIG. 2 is a system diagram illustrating a premises based network constructed according to the present invention that supports both wired local area network and wireless local area network operations;

FIG. 3 is a partial system diagram illustrating a portion of a campus in which wireless communications are serviced according to the present invention;

FIG. 4 is a block diagram partially illustrating a portion of a network of FIG. 3 that supports operations according to the present invention;

FIG. 5A is a logic diagram illustrating operation of WAPs according to the present invention in servicing wireless terminals;

FIG. 5B is a logic diagram illustrating registration operations according to the present invention in servicing wireless terminals;

FIG. 6 is a block diagram illustrating a multi-layer switch constructed according to the present invention; and

FIG. 7 is a block diagram illustrating a Wireless Access Point constructed according to the present invention.

### DETAILED DESCRIPTION OF THE DRAWINGS

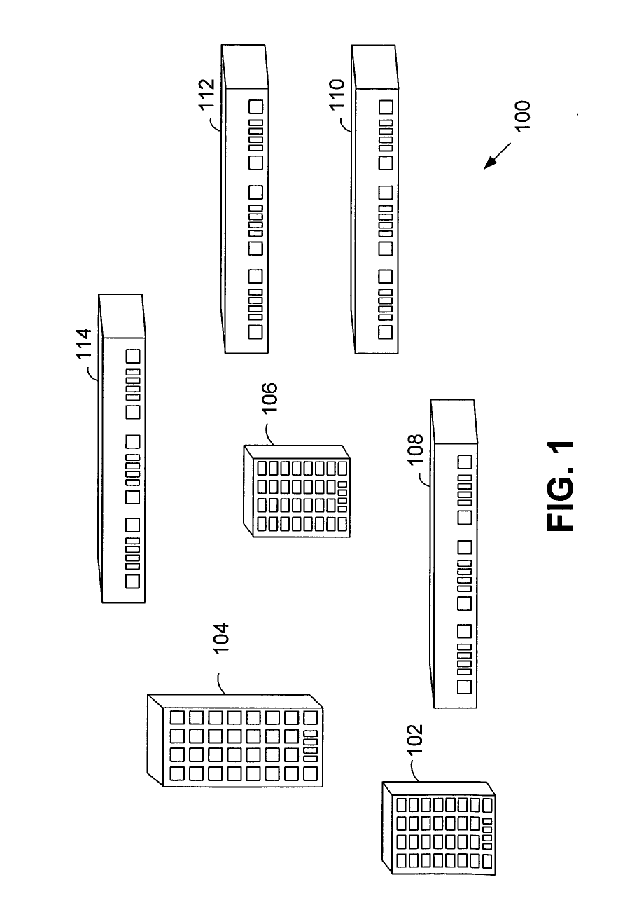

FIG. 1 is a system diagram illustrating a premises 100 in which a network constructed according to the present invention is deployed. The premises 100 (campus) includes office buildings 102, 104, 106 and industrial buildings 108, 110, 112, and 114. The premises 100 may correspond to a company such as a technology company, a seller of goods, a service company, or another type of company. Contained within each of the office buildings 102, 104, and 106 are a number of offices, each of which provides a working space for at least one person. Each of the industrial buildings 108, 110, 112, and 114 provides space for manufacturing, storage, or another purpose. People also work within industrial buildings 108, 110, 112, and 114.

Contained within each of these buildings 102-114 are computer workstations, computer servers, printers, FAX machines, phones, and other electronic devices. Each of these electronic devices has its communication requirements. For example, computer workstations, computer servers, and printers each require data communication service. Such data communication service requires that the devices can communicate with other devices located within the premises 100 and with devices located external to the premises 100 across one or more data networks. The FAX machines and phones require coupling to one another and to the Public Switched Telephone Network (PSTN).

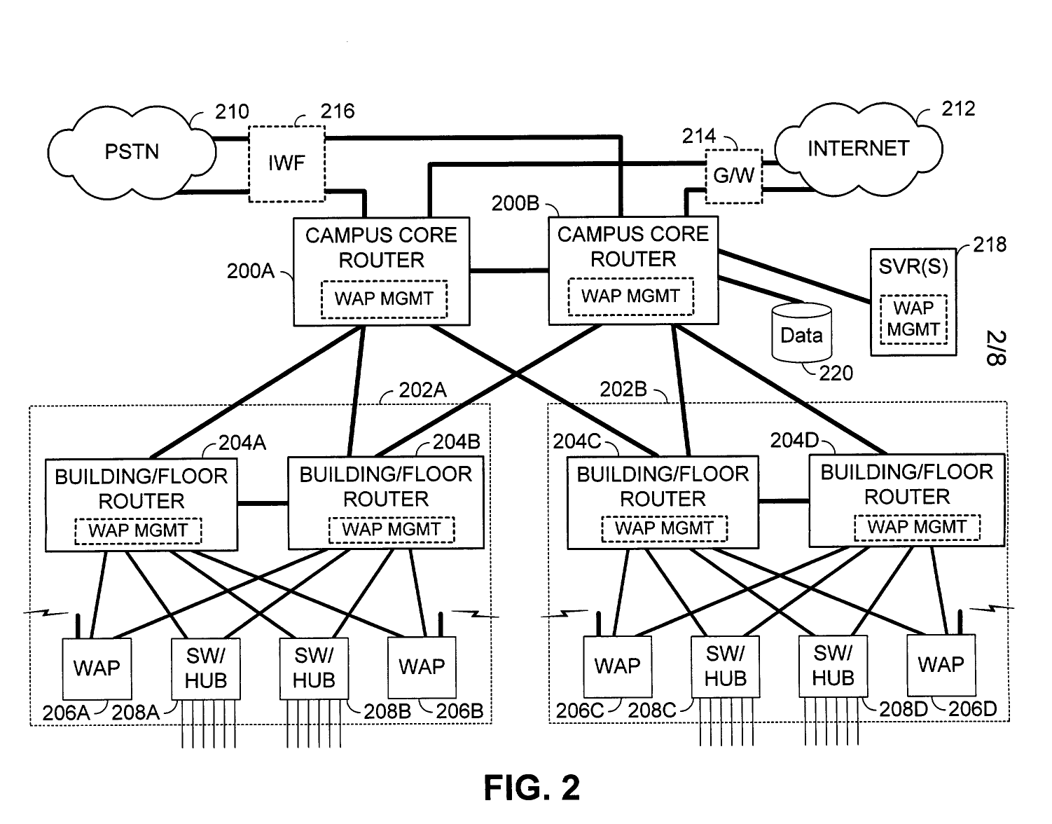

According to the present invention, both wired and wireless communications are supported within the premises 100 via a network that provides both wired Local Area Network (wired LAN) and Wireless Local Area Network (WLAN) functionality. The manner in which the network is constructed and the manner in which the wired LAN and WLAN functionality are provided are described further with reference to FIGS. 2 through 8.

FIG. 2 is a system diagram illustrating a premises based network constructed according to the present invention that supports both wired LAN and WLAN operations. Illustrated in FIG. 2 are some of the components of the network infrastructure that support the premises 100 of FIG. 1. The network includes a pair of campus core routers 200A and 200B that redundantly service the premises 100. Both of the campus core routers 200A and 200B couple to the PSTN 210, via an Inter Working Function “IWF” in some embodiments. Both of the campus core routers 200A and 200B also couple to the Internet 212, via a Gateway or Firewall 214 in some embodiments. As is generally known, the PSTN 210 services conventional voice communications but may also service packet data communications, e.g., Digital Subscriber Lines, etc. The Internet 212 services most packet data communications for the premises 100 and may service Internet Protocol (IP) telephony as well. As should be appreciated by the reader, the campus core routers 200A and 200B may couple to other networks across the Internet 212 or via dedicated network connections.

Each building serviced by the network includes its own building network infrastructure. Each building network infrastructure includes components contained within dotted lines 202A and 202B, for example. Each of the office buildings 102, 104, and 106 shown in FIG. 1 includes a building network infrastructure. The building network infrastructure 202A includes building/floor routers 204A and 204B that service a plurality of wired network switches/hubs 208A and 208B and a plurality of Wireless Access Points (WAPs) 206A and 206B. The communication links between the building/floor routers 204A and 204B and the campus core routers 200A and 200B are typically at a relatively high data rate, e.g., 1000 Mbps. The communication links between the building/floor routers 204A and 204B and the WAPs 206A and 206B and the switches/hubs 208A and 208B are also typically at the relatively high data. However, client connections to the switches/hubs 208A and 208B are typically at a relatively lower data rate, e.g., 100 Mbps or 10 Mbps. The building network infrastructure 202B services another building and includes building/floor routers 204C and 204C, switches/hubs 208C and 208D, and WAPs 206C and 206D.

The switches/hubs 208A-208D service a plurality of wired LAN clients, e.g., desktop computers, wired phones, and other wired LAN devices. The WAPs 206A-206D service wireless network clients, e.g., laptop computers, wireless terminals, but may also service other devices that cannot easily access a wired LAN plug, such as a desktop computer. The WAPs 206A-260D operate may operate according to a standardized communication protocol, e.g., IEEE 802.11(a), IEEE 802.11(b), IEEE 802.11(g), etc. In combination, these devices service most, if not all of the packet communications within the premises 100 of FIG. 1. Of course, the structure of FIG. 2 is an example only and an actual implementation would include substantially more equipment and more links.

At least one server 218 and at least one database 220 couple to the campus core router 200B and/or the campus core router 200A. The server 218 includes at least one network management server and at least one call management server. The network management server is used to manage many of the network components. While the database 220 the server 218 are shown to reside external to the campus core routers 200A, the components could also be located within a common housing and/or be implemented by the processing components of the campus core routers 200A.

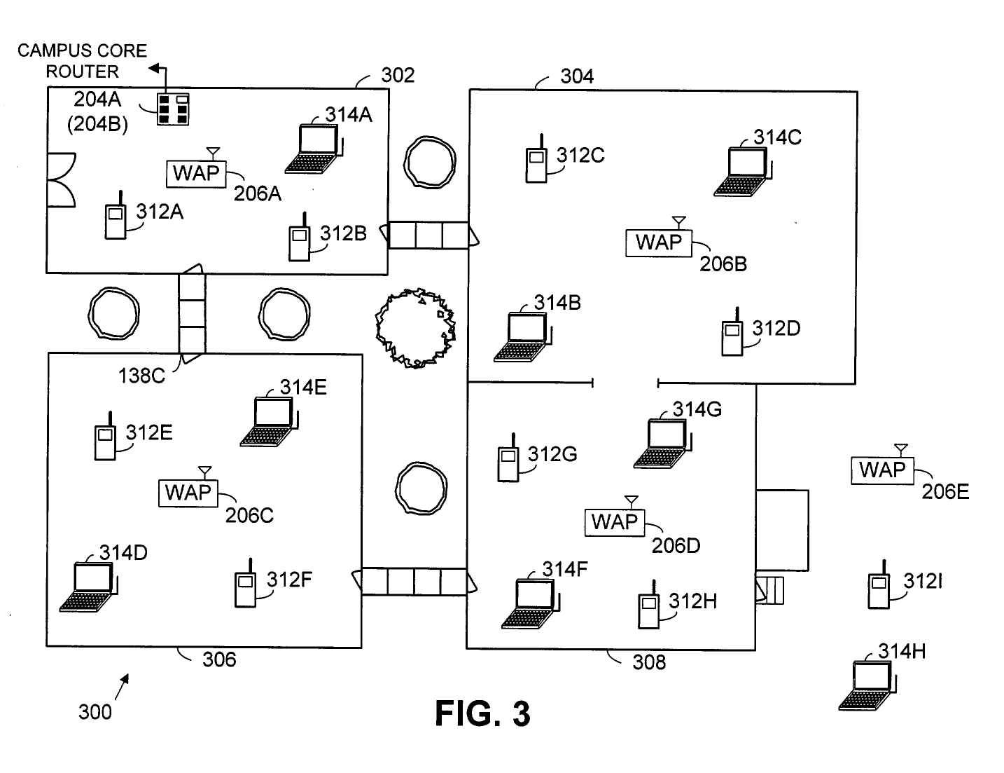

The campus core routers 200A and 200B and/or the building/floor routers 204A, 204B, 204C and/or 204C and the servers 218 support Wireless Access Point (WAP) management according to the present invention. The campus core routers 200A and 200B and/or the building/floor routers 204A, 204B, 204C and/or 204C are referred to as multi-layer switches further herein and the management operations that they may perform according to the present invention are described further with reference to FIGS. 3 through 8. These operations are typically implemented in software but may be implemented partially in software and partially in hardware. Likewise, the server 218 also performs WAP management operations according to the present invention by the execution of software instructions and hardware operations. The server 218 is also referred to herein as the network manager. The server 218 includes a processor, memory, storage, and an interface to the WLAN. The structure of server computers (and other digital computers) is well known and will not be further described herein except as it relates to the present invention.

FIG. 3 is a partial system diagram illustrating a portion of a campus in which wireless communications are serviced according to the present invention. A building floor 300 shown in FIG. 3 is part of the campus and may be a lower floor of one of the buildings of FIG. 1, e.g., building 102. The building floor 300 includes a plurality of rooms 302, 304, 306, and 308. Each of these rooms 302, 304, 306, and 308 includes a WAP 206A, 206B, 206C, and 206D, respectively, that services a corresponding area. Further, an external WAP 206E provides service external to room 308 of building floor 300. Each of these WAPs 206A-206E couples to a servicing building/floor router 204A or 204B via the wired LAN backbone. The servicing building/floor router 204A or 204B couples to the campus core router 200A (or 200B) as shown in FIG. 2.

Serviced within the building floor 300 are wireless terminals 312A-312I and laptop computers 314A-314H. Each of these devices wirelessly communicates with a servicing WAP. For example, laptop computer 314A and wireless terminals 312A and 312B wirelessly communicate with WAP 206A (in their illustrated positions). Each of the WAPs 206A-206D supports wireless communications primarily within a designated area, rooms 302-308, respectively. However, the coverage area of each WAP 206A-206D extends beyond the boundaries of its respective rooms 302-308 so that overlapping coverage areas exist. For example, WAPs 206A and 206C provide service between rooms 302 and 306 so that wireless terminals that roam between the rooms continue to receive wireless communication service when between the rooms 302 and 306. Further, WAP 206E supports wireless communications outside of the floor 300 to service laptop computer 314H and wireless terminal 312I. Note that the WAP placement of FIG. 3 is an example only and that each room may contain multiple WAPs or that a single WAP may cover multiple rooms.

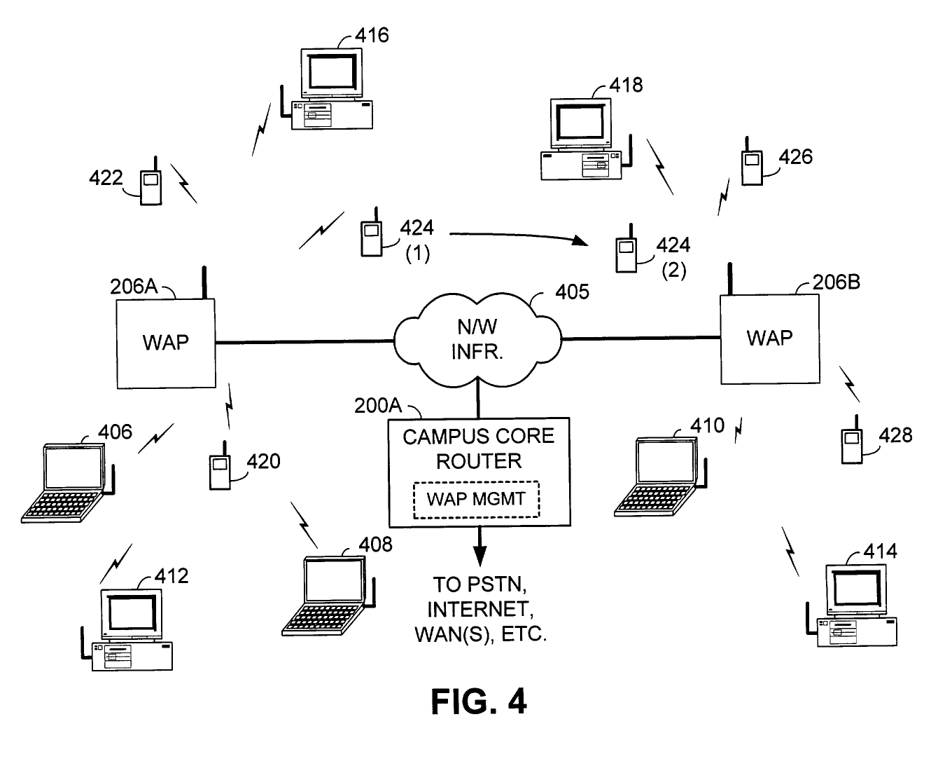

FIG. 4 is a block diagram partially illustrating a portion of a network of FIG. 3 that supports operations according to the present invention. The portion of the network shown includes WAPs 206A and 206B that support wireless communications within a jointly serviced area, for example, the rooms 302 and 304 of FIG. 3. The WAPs 206A and 206B couple to the network infrastructure 405, e.g., the network infrastructure shown in FIG. 2. The WAPs 206A and 206B service wireless communications for laptop computers 406, 408, and 410, desktop computers 412, 414, 416, and 418, and wireless terminals 420, 422, 422, 424, 426, and 428. The service coverage areas provided by WAPs 206A and 206B partially overlap. The network infrastructure 405 couples to one or more servicing multi-layer switches, e.g., campus core router 200A that includes WAP management functionality according to the present invention.

According to one aspect of the present invention, WAPs 206A and 206B are managed to reduce registration and authentication overhead for roaming terminals. In prior operations, each time that a terminal established service with a different WAP, the WAP performed registration and authentication for the terminal, a process that may take seconds. Such registration and authentication processes are inconsistent with the low latency requirements of voice calls. Further, the delay caused by the registration and authentication process could also disrupt large data transfers. Thus, according to the present invention, registration and authentication operations are streamlined, reduced, or eliminated for users registered with the WLAN. While registration and authentication will still be required for wireless terminals that transition between WAPs, it will be limited in scope to reduce or eliminate any disruption in service.

For example, when wireless terminal 424 moves from position (1) serviced by WAP 206A to position (2) serviced by WAP 206B, in prior systems, registration and authentication operations would cause an approximate two-second gap in service. Such gap in service would not only disrupt an ongoing voice communication, it could cause the call to be either automatically or manually terminated. According to the present invention, when the wireless terminal 424 registers with WAP 206B, it is immediately registered and serviced, without intervening delay.

According to another aspect of the present invention, visitor access to the WLAN is supported in a limited fashion. With this operation, visiting laptop computers (and other devices) that are WLAN enabled and that enter the service area of the WLAN are provided limited access to the WLAN. With this limited access, the visiting laptop computers may access the Internet and other external networks. Such limited access may be provided by configuring a Virtual Private Network (VPN) for each visiting wireless terminal within the WLAN. A particular VPN is configured to service communications for the visiting laptop computer between a servicing WAP and a router at the edge of the network and to preclude the visiting laptop from accessing any other portion of the network. In this manner, switches between the servicing WAP, e.g., WAP 206A and an edge node, e.g., campus core router 200A or 200B are configured to route all traffic sent from, and intended for the visiting laptop directly between the router at the edge node of the network and the servicing WAP. These operations improve security for the network while providing the wireless visitors with access to outside networks. According to a particular implementation of this operation, a single WAP, e.g., WAP 206A located in the lobby of building floor 300 may be enabled to service VPNs. In such case, as a visiting wireless terminal roamed from the service area of the WAP 206A, it would not be serviced by the other WAPs 206B, 206C, 206D, and 206E.

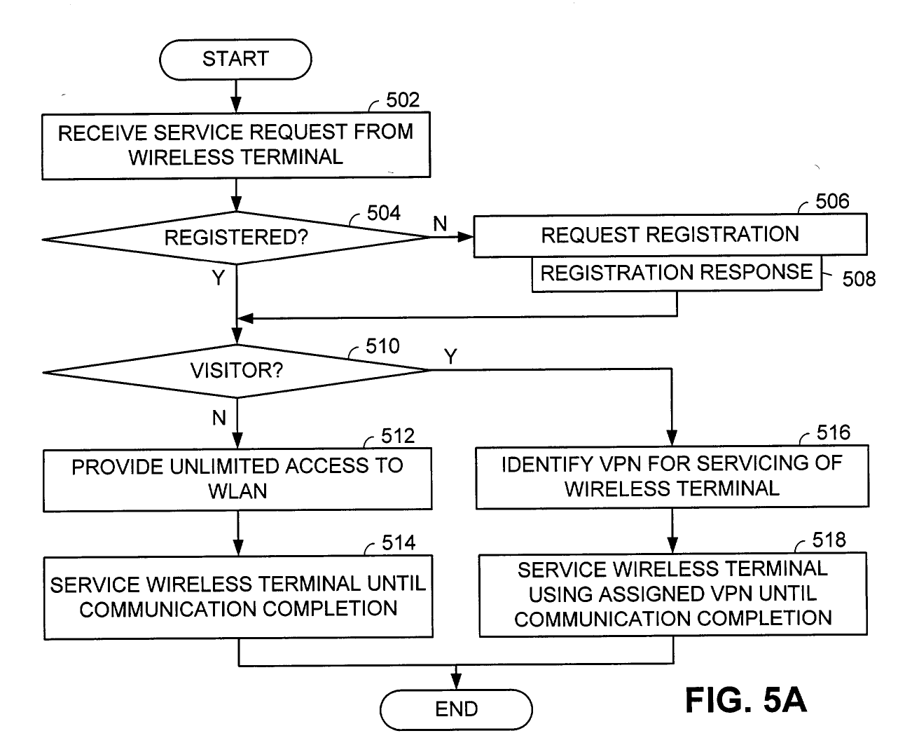

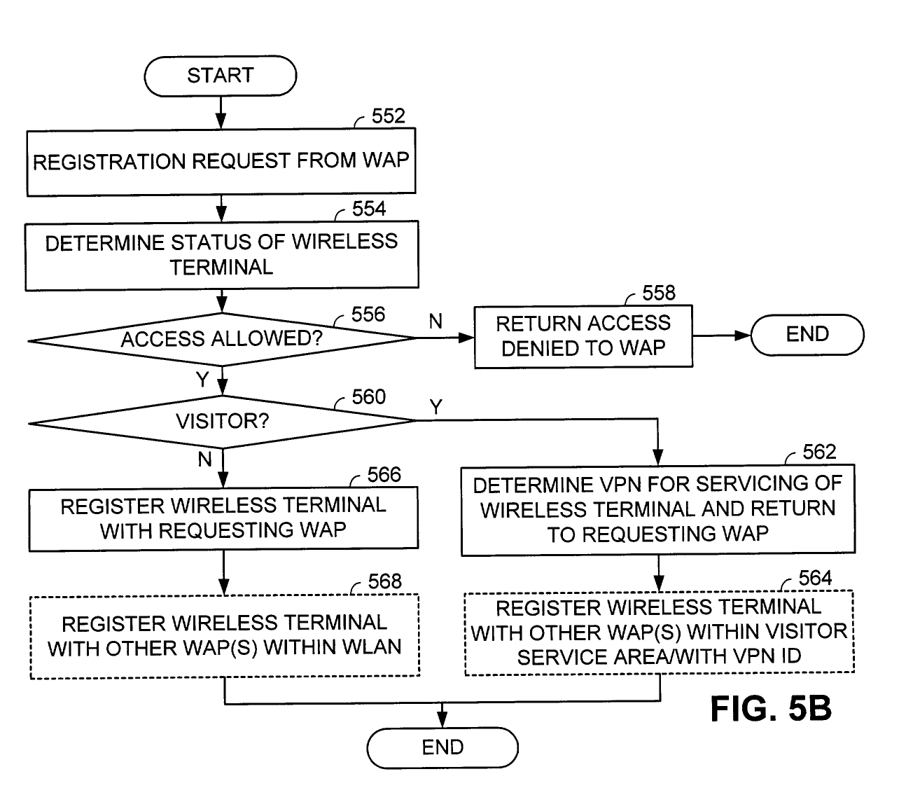

FIG. 5A is a logic diagram illustrating operation of WAPs according to the present invention in servicing wireless terminals. Operation commences when a WAP receives a service request from a wireless terminal entering/operating within the WAP's service area (step 502). The WAP then determines whether the wireless terminal is currently registered with the WAP (step 504). If the wireless terminal is not currently registered with the WAP, the WAP sends a registration request to a servicing network manager, e.g., server 218 (step 506) and awaits a response. After the network manager services the registration request, it responds to the WAP with a registration response (step 508).

From step 508, and from step 504 when the wireless terminal was registered with the WAP, proceeds to step 510 where the WAP determines if the wireless terminal is a visitor to the WLAN (or WAP). If the wireless terminal is not a visitor, the WAP provides the wireless terminal with unlimited access to the WLAN (step 512). Then, the WAP services the wireless terminal until its communication is completed (step 514). The wireless terminal's communication is completed with the WAP when the communication itself ceases or when the wireless terminal roams to the service area of another WAP.

If the WAP determines that the wireless terminal is a visitor to the WLAN (or WAP) at step 510 the WAP identifies a VPN, e.g., VPN ID, that will be employed in servicing the wireless terminal (step 516). The WAP then services the wireless terminal using the VPN ID until the communication is completed (step 518). In servicing the wireless terminal using the VPN ID, all communications are routed between the WAP and an edge node of the WLAN, e.g., campus core router 206A/206B. As will be described further with reference to FIG. 5B, a network manager assists in setting up VPNs within the WLAN.

FIG. 5B is a logic diagram illustrating registration operations according to the present invention in servicing wireless terminals. In one particular implementation of the present invention, a network manager (or multi-layer switch) performs the operations of FIG. 5B. Operation commences when the network manager receives a registration request from a WAP of the WLAN (step 552). The network manager then determines the status of the wireless terminal (step 554). In particular, the network manager determines whether the wireless terminal is authorized to access the WLAN via access to stored permission records. In one particular embodiment, a system manager downloads the MACs of authorized wireless terminals to the network manager and the network manager, the network manager stores these MACs and, at step 554, the network manager accesses these stored MACs to determine if the wireless terminal in question is a registered user.

Based upon the information that is accessed, the network manager determines whether the wireless terminal has access to the WLAN (step 556). According to one embodiment of the present invention, wireless terminals either are registered users or are visitors. In another embodiment, visitors are required to pre-register as visitors. In the second case, any wireless terminal that is a visitor and has not pre-registered will be denied access to the WAP (step 558). In such case, the network manager will notify the requesting WAP to deny access to the wireless terminal and registration operations end.

If the wireless terminal is allowed access, the network manager determines whether the wireless terminal is a visitor (step 560). If the wireless terminal is not a visitor, the network manager registers the wireless terminal with the servicing WAP (step 566). Then, according to another operation of the present invention, the network manager operationally registers the wireless terminal with other WAPs within the WLAN (step 568). If the wireless terminal is a visitor, the network manager determines a VPN that may be used for servicing the wireless terminal and returns the VPN ID to the requesting WAP (step 562). The network manager also sets up the VPN within the WLAN so that all communications from the visiting wireless terminal are routed to a servicing edge device, e.g., campus core router. Then, according to another operation of the present invention, the network manager operationally registers the visiting wireless terminal with other WAPs within the WLAN that service visitors (step 568). From both step 564 and step 568 operation ends.

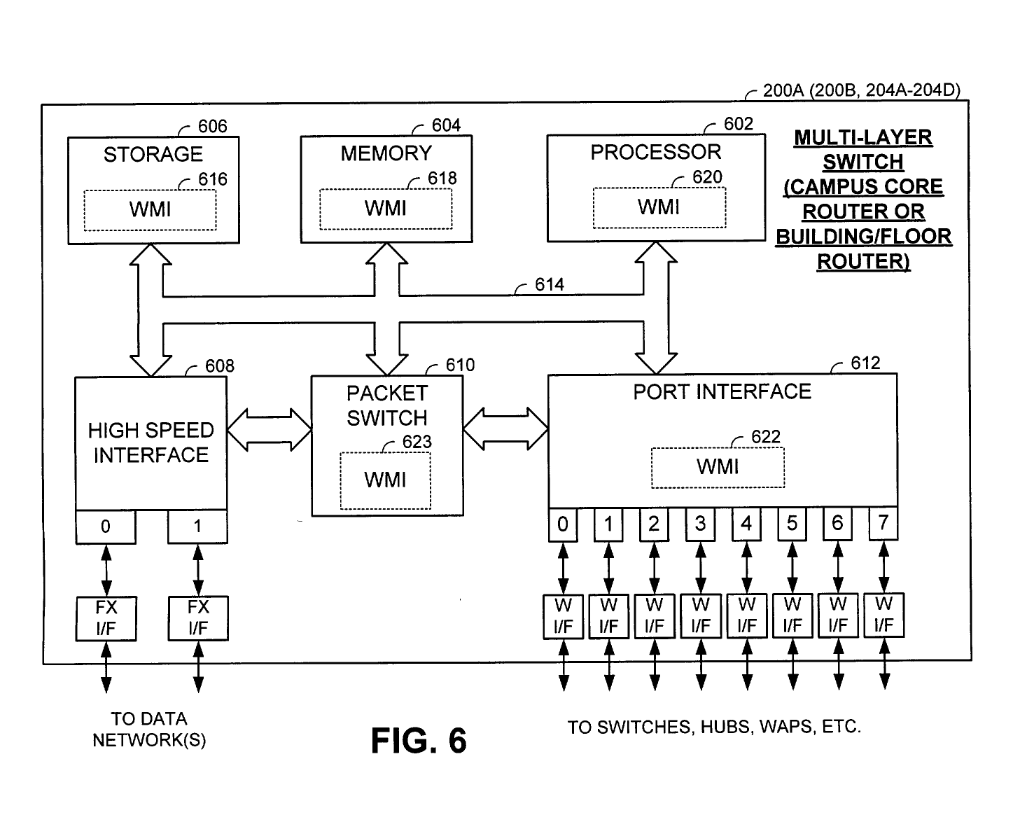

FIG. 6 is a block diagram illustrating a multi-layer switch, e.g., multi-layer switch 200A (or 200B) or building/floor router 204A-204D constructed according to the present invention. The structure illustrated in FIG. 6 is a diagrammatic representation of the structure of the multi-layer switch of FIG. 2 with minimal detail. As the reader will appreciate, other structures will support operation according to the present invention and the structure of FIG. 6 is only one example the structure of a multi-layer switch. The multi-layer switch 200A includes a processor 602, memory 604, storage 606, a high-speed interface 608, and a port interface 612, all of which couple via a system bus 614. Also contained within the multi-layer switch 200A is a packet switch 610 that couples to high-speed interface 608, port interface 612, and the system bus 614. The high-speed interface 608 either couples to a plurality of data networks or couples redundantly to a single data network. These interconnections are designated to be fiber interconnections. However, the interconnections could also be wired connections. With the structure of FIG. 2, for example, the high-speed interface 608 couples the multi-layer switch 200A to the gateway 214 and to the IWF 216. The port interface 612 includes eight ports and couples the multi-layer switch 200A to the wired network infrastructure of the LAN. Other embodiments of the port interface 612 of the multi-layer switch 200A may include a greater number, or a lesser number of ports.

In order to operate according to the present invention, the multi-layer switch 200A performs software and/or hardware operations. The instructions and operations that cause the multi-layer switch 200A to operate according to the present invention are referred to as WAP Management Instructions (WMI). When the WMI are implemented as software instructions, WMI are initially stored as WMI 616 in storage 606. The storage 606 may be an optical media, a hard drive, or other substantially static storage device. Memory 604 may include dynamic random access memory, read-only memory, or another type of memory that is known in the arts to facilitate the storage of instructions and data and that may be accessed by processor 602. Processor 602 may be a single microprocessor, multiple microprocessors, a processing module, or another processing device that is capable of executing software instructions and controlling the operation of other multi-layer switch 200A components coupled via system bus 614.

In executing the WMI 616, the WMI 616 are copied from storage 606 to memory 604 as WMI 618 and then read by the processor 602 from memory 604 as WMI 620. The execution of the WMI 620 by the processor 602 causes the processor to program/control the operation of the port interface 612 to operate according to the present invention. The processor 602 may then configure WMI 622 in the port interface 612 and/or WMI 623 in the packet switch 610. Such configuration may include programming routing tables with values and parameters. In combination, the WMI operations 620 performed by the processor, the WMI 622 performed by the port interface 612, and the WMI 623 performed by the packet switch enable the multi-layer switch 200A to operate according of the present invention.

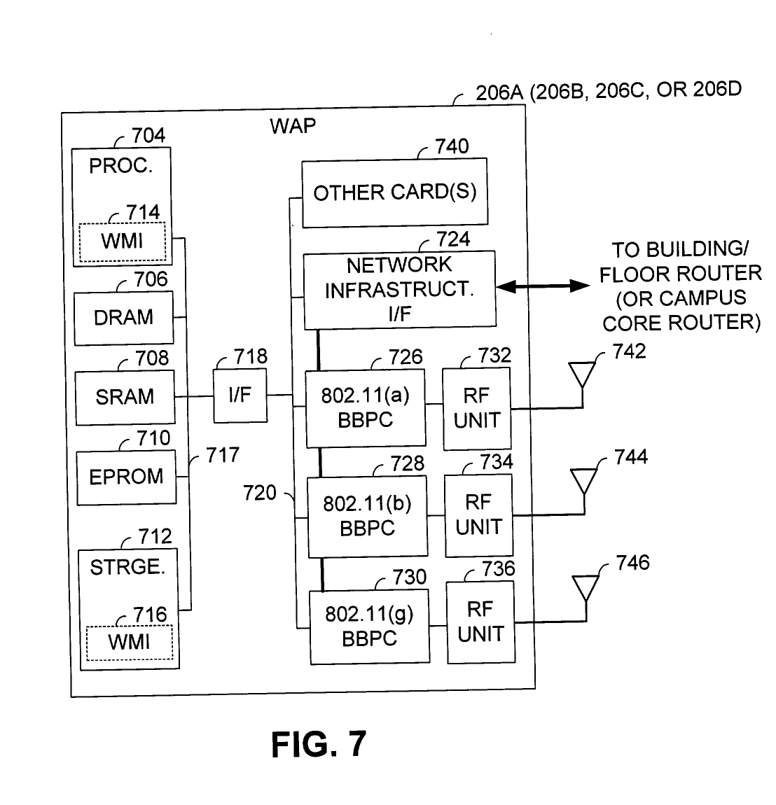

FIG. 7 is a block diagram illustrating a Wireless Access Point (WAP) 106A, 106B, 106C, or 106D constructed according to the present invention. The WAP 106A includes a processor 704, dynamic RAM 706, static RAM 708, EPROM 710, and at least one data storage device 712, such as a hard drive, optical drive, tape drive, etc. These components (which may be contained on a peripheral processing, card or module) intercouple via a local bus 717 and couple to a peripheral bus 720 via an interface 718.

Various peripheral cards couple to the peripheral bus 720. These peripheral cards include a network infrastructure interface card 724, which couples the WAP 103 to its servicing building/floor router (or core router). Baseband processing cards 726, 728 and 730 couple to Radio Frequency (RF) units 732, 734, and 736, respectively. Each of these baseband processing cards 726, 728, and 730 performs digital processing for a respective wireless communication protocol, e.g., 802.11(a), 802.11(b), and 802.11(g), serviced by the WAP 206A. The RF units 732, 734, and 736 couple to antennas 742, 744, and 746, respectively, and support wireless communication between the WAP 103 and wireless subscriber units. The WAP 103 may include other card(s) 740 as well. While the WAP 206A illustrated in FIG. 7 is shown to support three separate wireless communication protocols, other embodiments of the WAP 206A could support one, two, or more than three communication protocols.

The WAP 206A performs operations according to the present invention that are embodied at least partially as software instructions, i.e., WMI. WMI 714 enable the WAP 206A to perform the operations of the present invention. The WMI 716 are loaded into the storage unit 712 and some or all of the WMI 714 are loaded into the processor 704 for execution. During this process, some of the WMI 716 may be loaded into the DRAM 706.The invention disclosed herein is susceptible to various modifications and alternative forms. Specific embodiments therefore have been shown by way of example in the drawings and detailed description. It should be understood, however, that the drawings and description thereto are not intended to limit the invention to the particular form disclosed, but on the contrary, the invention is to cover all modifications, equivalents and alternatives falling within the spirit and scope of the present invention as defined by the claims.

1. In a premises based Wireless Local Area Network (WLAN) that includes a wired network infrastructure, a plurality of Wireless Access Points (WAPs) coupled to the wired network infrastructure, and a network manager coupled to the wired network infrastructure, a method of operation comprising:
receiving, at a servicing WAP of the plurality of WAPs, a service request from a wireless terminal;
sending, by the servicing WAP to the network manager, a registration request for the wireless terminal;
determining, by the network manager, that the wireless terminal is to be allowed access to the WAP;
responding, from the network manager to the servicing WAP, that the wireless terminal is to be allowed access to the WAP;
providing, by the servicing WAP, WLAN service to the wireless terminal;
providing, by the network manager to at least one other WAP of the plurality of WAPs, registration information regarding the wireless terminal;
receiving, at another servicing WAP of the plurality of WAPs, a request for service from the wireless terminal; and
based upon registration information previously received from the network manager, providing, by the another servicing WAP, WLAN service to the wireless terminal resulting in reduced latency in receiving service from the another servicing WAP.

2. The method of claim 1, wherein WLAN service is provided by the another servicing WAP without requiring a registration request from the another servicing WAP to the network manager.

3. The method of claim 1, wherein providing, by the network manager to at least one other WAP of the plurality of WAPs, registration information regarding the wireless terminal includes providing the registration information to each other of the plurality of WAPs.

4. The method of claim 1, wherein providing, by the network manager to at least one other WAP of the plurality of WAPs, registration information regarding the wireless terminal includes providing the registration information to a subset of the other WAPs of the plurality of WAPs.

5. The method of claim 1, wherein:
determining, by the network manager, that the wireless terminal is to be allowed access to the WAP includes determining that the wireless terminal is a visitor to the WLAN and assigning a Virtual Private Network (VPN) ID to the wireless terminal;
responding, from the network manager to the servicing WAP, that the wireless terminal is to be allowed access to the WAP includes providing the servicing WAP with the VPN ID; and
providing, by the servicing WAP, WLAN service to the wireless terminal includes:
routing all communications received from the wireless terminal to an edge node of the WLAN; and
precluding the wireless terminal's access to other portions of the WLAN.

6. The method of claim 1, wherein the network manager is embodied in a multi-layer switch that also performs switching operations within the WLAN.

7. In a premises based Wireless Local Area Network (WLAN) that includes a wired network infrastructure, a plurality of Wireless Access Points (WAPs) coupled to the wired network infrastructure, and a network manager coupled to the wired network infrastructure, a method of operation comprising:
receiving, at a servicing WAP of the plurality of WAPs, a service request from a wireless terminal;
sending, by the servicing WAP to the network manager, a registration request for the wireless terminal;
determining, by the network manager, that the wireless terminal is visiting the WLAN, is to be allowed access to the WAP, but is allowed limited access to the WLAN;
assigning a Virtual Private Network (VPN) ID to the wireless terminal;
responding, from the network manager to the servicing WAP, with the VPN ID;
providing, by the servicing WAP, WLAN service to the wireless terminal; and
routing, by the servicing WAP, all communications received from the wireless terminal to an edge node of the WLAN.

8. The method of claim 7, further comprising:
providing, by the network manager to at least one other WAP of the plurality of WAPs, registration information regarding the wireless terminal including the VPN ID.
receiving, at another servicing WAP of the plurality of WAPs, a request for service from a wireless terminal; and
based upon registration information previously received from the network manager, providing, by the another servicing WAP, WLAN service to the wireless terminal based upon the VPN ID.

9. The method of claim 7, wherein WLAN service is provided by the another servicing WAP without requiring a registration request from the another servicing WAP to the network manager.

10. The method of claim 7, wherein providing, by the network manager to at least one other WAP of the plurality of WAPs, registration information regarding the wireless terminal includes providing the registration information to each other of the plurality of WAPs.

11. The method of claim 7, wherein providing, by the network manager to at least one other WAP of the plurality of WAPs, registration information regarding the wireless terminal includes providing the registration information to a subset of the other WAPs of the plurality of WAPs, wherein the subset of the other WAPs service designated visitor areas within a serviced premises.

12. The method of claim 7, wherein the network manager is embodied in a multi-layer switch that also performs switching operations within the WLAN.

13. In a premises based Wireless Local Area Network (WLAN) that includes a wired network infrastructure, a plurality of Wireless Access Points (WAPs) coupled to the wired network infrastructure, and a network manager coupled to the wired network infrastructure, a method of operation comprising:
receiving a service request at a WAP of the plurality WAPs from a visiting wireless terminal;
determining that the wireless terminal should have visitor access rights to the WLAN;
allocating a Virtual Private Network (VPN) for the service of the wireless terminal;
establishing the VPN between the WAP and an external network; and
servicing the wireless terminal using the VPN between the WAP and the external network.

14. The method of claim 13, wherein the WLAN precludes the wireless terminal from accessing components of the WLAN other than the WAP and a WLAN component that couples the WLAN to the external network.

15. A Wireless Local Area Network (WLAN) comprising:
a network infrastructure;
a plurality of Wireless Access Points (WAPs) coupled to the network infrastructure;
a network manager coupled to the network infrastructure;
wherein a servicing WAP of the plurality of WAPs receives a service request from a wireless terminal;
wherein the servicing WAP sends a registration request to the network manager requesting registration of the wireless terminal;
wherein the network manager determines that the wireless terminal is to be allowed access to the WAP;
wherein the network manager responds to the servicing WAP that the wireless terminal is to be allowed access to the WAP;
wherein the servicing WAP provides WLAN service to the wireless terminal;
wherein the network manager provides registration information regarding the wireless terminal to at least one other WAP of the plurality of WAPs;
wherein another servicing WAP of the plurality of WAPs receives a service request from the wireless terminal; and
wherein the another servicing WAP provides service to the wireless terminal based upon registration information previously received from the network manager and so that latency in handoff is reduced.

16. The WLAN of claim 15, wherein WLAN service is provided by the another servicing WAP without requiring a registration request from the another servicing WAP to the network manager.

17. The WLAN of claim 15, wherein the registration information regarding the wireless terminal is provided to each other of the plurality of WAPs.

18. The WLAN of claim 15, wherein the registration information regarding the wireless terminal is provided to a subset of the other WAPs of the plurality of WAPs.

19. A Wireless Local Area Network (WLAN) comprising:
a network infrastructure;
a plurality of Wireless Access Points (WAPs) coupled to the network infrastructure;
a network manager coupled to the network infrastructure;
wherein a WAP of the plurality WAPs receives a service request from a visiting wireless terminal;
wherein the network manager determines that the wireless terminal should have visitor access rights to the WLAN;
wherein the network manager allocates a Virtual Private Network (VPN) for the service of the wireless terminal;
wherein the network manager establishes the VPN between the WAP and an external network; and
wherein the WLAN services the wireless terminal using the VPN between the WAP and the external network.

20. The WLAN of claim 19, wherein the WLAN precludes the wireless terminal from accessing components of the WLAN other than the WAP and a WLAN component that couples the WLAN to the external network.
